(19) United States
(12) Patent Application Publication
(10) Pub. No.: US 2008/0224868 A1
(43) Pub. Date: Sep. 18, 2008

(54) Property anti-theft apparatus

(76) Inventor: Dennis Huang, Taipei (TW)

Correspondence Address: BACON & THOMAS, PLLC, 625 SLATERS LANE, FOURTH FLOOR, ALEXANDRIA, VA, 22314-1176, US

(21) Appl. No.: 11/892,199

(22) Filed: Aug. 21, 2007

(30) Foreign Application Priority Data
Mar. 13, 2007 (TW) 096108561

(51) Int. Cl. G08B 13/14

(52) U.S. Cl. 340/572.1

(57) ABSTRACT

A property anti-theft apparatus includes a transmitting unit and a receiving unit. The transmitting unit is installed on a property, and the transmitting unit includes a sensing device and a radio transmitting circuit. The sensing device is used for sensing a movement of the property. When the sensing device senses that the movement of the property exceeds a predetermined distance, it triggers the radio transmitting circuit to transmit a radio signal. The receiving unit is used for receiving the radio signal, so as to alert the movement of the property.

### BACKGROUND OF THE INVENTION

1. Field of the Invention

The present invention relates to a property anti-theft apparatus, and more particularly, to an anti-theft apparatus applicable for a property in exhibition or in public use.

2. Description of Related Art

Conventionally, the methods for preventing a property from being stolen or damaged are nothing but locking the property, blocking the property, or installing a variety of alarms around the property, thus issuing an alert to deter the thief when the property is moved. However, the conventional methods for preventing the property from being stolen are not suitable for those properties in exhibition or in public use.

Regarding the anti-theft method of locking the property or blocking the property from the exterior for use in the products exhibited in the market place, though such anti-theft method does avoid the products from being stolen by means of locking those products within a glass showcase, consumers would lower their will of purchasing the products because they're unable to view the products in detail.

Another anti-theft method utilizes a theft-preventing alarm. Therefore, when the distance between the property and a user exceeds a predetermined distance, an alert would be issued. Such theft-preventing alarms used for preventing suitcases, briefcases, cellular phones or the like from being lost are all equipped with a transmitting device, and a receiving and alarm device, wherein the transmitting device is carried along with the user for transmitting radio waves, while the receiving and alarm device is installed on the property. When the distance between the user and the property exceeds a predetermined range, the receiving and alarm device couldn't receive transmitted signals from the transmitting device, thereby activating its alarm circuit to issue an alert signal to inform the user, so as to prevent the property from being lost or stolen by a thief. However, such theft-preventing alarm requires the user who carries the transmitting device to be around the property. Further, within the predetermined range, the alert signal wouldn't be issued even if the property has been arbitrarily moved. As a result, it is not suitable for preventing a property in exhibition or in public use from being stolen or damaged.

Therefore, it is desirable to provide an improved anti-theft apparatus in a more convenient and accurate way so as to mitigate and/or obviate the aforementioned problems.

### SUMMARY OF THE INVENTION

The object of the present invention is to provide a property anti-theft apparatus for monitoring whether there is an abnormal situation, and for issuing an alert as well as tracking the location of the property when the property is stolen.

The present invention relates to a property anti-theft apparatus, which comprises a transmitting unit and a receiving unit. The transmitting unit is installed on a property, and comprises a sensing device and a radio transmitting circuit. The sensing device is used for sensing a movement of the property, wherein when the sensing device senses the movement of the property exceeds a predetermined distance, the sensing device triggers the radio transmitting circuit to transmit a radio signal. While the receiving unit is used for receiving the radio signal so as to alert the movement of the property.

According to one preferred embodiment of the property anti-theft apparatus of the present invention, the abovementioned sensing device has a latch circuit. When the sensing device senses the movement of the property exceeds a predetermined distance to cause the property from an initial state to an alert state, the latch circuit is used to prevent the sensing device from returning to the initial state.

According to one preferred embodiment of the property anti-theft apparatus of the present invention, the abovementioned property anti-theft apparatus further comprises a battery. When the initial state has been changed to the alert state, the battery would supply power to the radio transmitting circuit for transmitting the radio signal.

According to one preferred embodiment of the property anti-theft apparatus of the present invention, the abovementioned sensing device is a magnetic reed switch. The magnetic reed switch comprises a magnetic reed tube and a magnet. When a distance between the magnetic reed tube and the magnet exceeds the predetermined distance, the magnetic reed switch is triggered and the sensing device is changed from the initial state to the alert state.

According to one preferred embodiment of the property anti-theft apparatus of the present invention, the abovementioned sensing device is a micro switch. The micro switch comprises two pins and one terminal. When a distance between the terminal of the micro switch and a fixed protruding block exceeds the predetermined distance, the micro switch is triggered and the sensing device is changed from the initial state to the alert state.

According to one preferred embodiment of the property anti-theft apparatus of the present invention, the abovementioned sensing device is a photosensitive switch. The photosensitive switch comprises a photo diode and a photo transistor. When a distance between the photo diode and the photo transistor exceeds the predetermined distance, the photosensitive switch is triggered and the sensing device is changed from the initial state to the alert state.

According to one preferred embodiment of the property anti-theft apparatus of the present invention, the abovementioned transmitting unit further comprises an input device. The input device is used for inputting an identification code. The identification code represents relevant data of a corresponding property. And the radio signal transmitted by the radio transmitting circuit includes the identification code.

According to one preferred embodiment of the property anti-theft apparatus of the present invention, the abovementioned receiving unit comprises a first antenna. The first antenna is used for receiving the radio signal and acquiring the relevant data of the property according to the identification code of the radio signal.

According to one preferred embodiment of the property anti-theft apparatus of the present invention, the abovementioned receiving unit comprises a gain controller having a gain value, and a second antenna. The second antenna is used for receiving the radio signal transmitted by the radio transmitting circuit. The gain value varies in accordance with a magnitude of the radio signal transmitted by the radio transmitting circuit, and a location of the property would be confirmed by means of adjusting the gain controller to control the gain value.

Accordingly, the property anti-theft apparatus of the present invention installs a sensing device on a property. Such that when sensing a movement of the property exceeds a predetermined distance, a radio transmitting circuit issues a radio signal. When the receiving unit receives the radio signal, it issues an alert to inform there is an abnormal situation, and confirms a location of the property by means of tracking the signal.

### BRIEF DESCRIPTION OF THE DRAWINGS

FIG. 1 illustrates a schematic drawing of a property anti-theft apparatus of one preferred embodiment according to the present invention.

FIGS. 2A-2C illustrate schematic drawings of a sensing device of one preferred embodiment according to the present invention.

FIG. 3 illustrates a schematic drawing of a receiving unit of one preferred embodiment according to the present invention.

FIG. 4 illustrates a schematic drawing of a receiving unit of another preferred embodiment according to the present invention.

FIG. 5 illustrates a schematic drawing of a life jacket anti-theft apparatus of one preferred embodiment according to the present invention.

### DETAILED DESCRIPTION OF THE PREFERRED EMBODIMENT

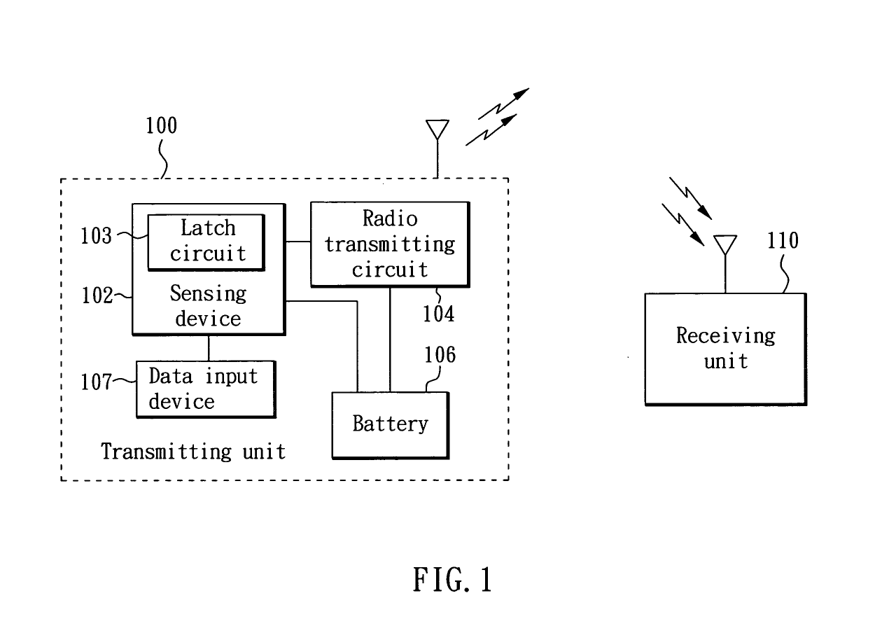

Please refer to FIG. 1. FIG. 1 illustrates a schematic drawing of a property anti-theft apparatus of one preferred embodiment according to the present invention. The property anti-theft apparatus includes: a transmitting unit 100 and a receiving unit 110. The transmitting unit 100 is installed on a property (not shown). The transmitting unit 100 includes a sensing device 102 and a radio transmitting circuit 104. The sensing device 102 is used for sensing a movement of the property. The sensing device 102 is under an initial state when it is normal condition. Whenever the sensing device 102 senses that the movement of the property exceeds a predetermined distance, the sensing device 102 would be changed to an alert state, and triggers the radio transmitting circuit 104 to transmit a radio signal. The receiving unit 110 is used for receiving the radio signal, so as to alert the movement of the property. The sensing device 102 is electrically connected to the radio transmitting circuit 104.

However, when the sensing device 102 senses that the movement of the property exceeds the predetermined distance to cause the property from the initial state to the alert state, the thief often uses a substitute article or means to quickly return the property to its normal initial state so as to avoid being noticed that the property has been stolen. Accordingly, in the property anti-theft apparatus of one preferred embodiment according to the present invention, the sensing device 102 has a latch circuit 103. When the sensing device 102 senses the movement of the property exceeds the predetermined distance to cause the property from the initial state to the alert state, the latch circuit 103 keeps the state of the sensing device 102 at the alert state, so as to prevent the sensing device 102 from returning to the initial state.

Please refer to FIG. 1 again. The property anti-theft apparatus of one preferred embodiment according to the present invention further includes a battery 106. The battery 106 supplies power to the sensing device 102 when the sensing device 102 is under the initial state, so as to keep the sensing device 102 at a standby state. Only when the sensing device 102 has been changed from the initial state to the alert state, the battery 106 would supply power to the radio transmitting circuit 104 for transmitting the radio signal. Therefore, power consumption could be efficiently saved so as to prolong the usage time of the property anti-theft device.

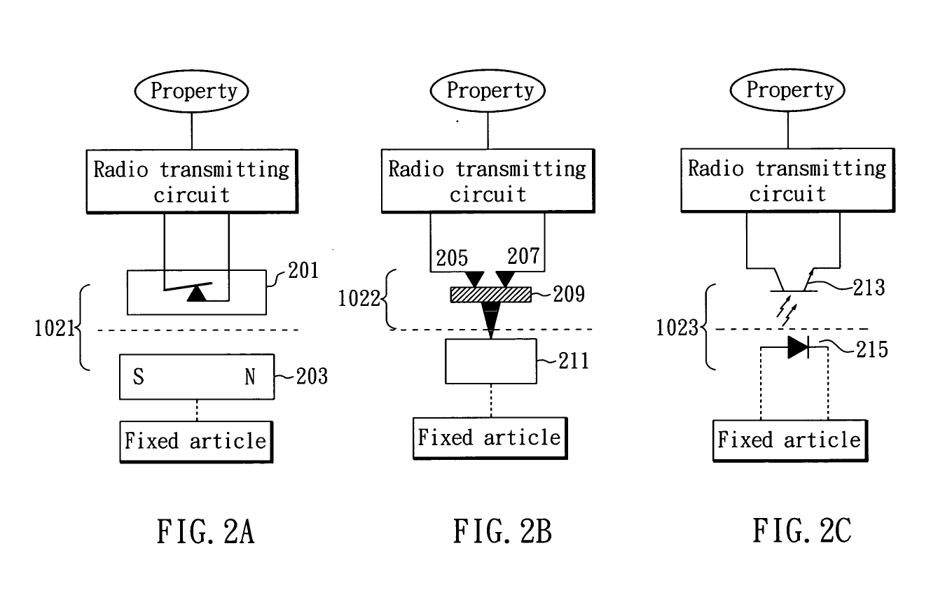

Please refer to both FIG. 1 and FIG. 2A. In the property anti-theft apparatus of one preferred embodiment according to the present invention, the sensing device 102 is a magnetic reed switch 1021. The magnetic reed switch 1021 includes a magnetic reed tube 201 and a magnet 203. The magnetic reed tube 201 and the magnet 203 are respectively installed on the property and a fixed article (such as a exhibition stand or any un-removable article). When the movement of the property is abnormal, that is, when a distance between the magnetic reed tube 201 and the magnet 203 exceeds the predetermined distance (such as the magnetism sensing range between the magnetic reed tube 201 and the magnet 203), the magnetic reed switch 1021 would be triggered and the sensing device 102 would be changed from the initial state to the alert state, so as to trigger the radio transmitting circuit 104 to transmit the radio signal.

Please refer to FIG. 1 and FIG. 2B. In the property anti-theft apparatus of one preferred embodiment according to the present invention, the sensing device 102 is a micro switch 1022. The micro switch 1022 includes a pin 205, a pin 207 and a terminal 209. The terminal 209 is positioned against a protruding block 211 so as to connect the pin 205 and the pin 207. The micro switch 1022 and the protruding block 211 are respectively installed on the property and a fixed article (such as a exhibition stand or any un-removable article). When the movement of the property is abnormal, that is, when a distance between the terminal 209 of the micro switch 1022 and the protruding block 211 exceeds the predetermined distance to cause the terminal 209 no longer positioned against the protruding 211, the micro switch 1022 would be triggered (to disconnect the pin 205 and the pin 207) and the sensing device 102 would be changed from the initial state to the alert state, so as to trigger the radio transmitting circuit 104 to transmit the radio signal.

Please refer to both FIG. 1 and FIG. 2C. In the property anti-theft apparatus of one preferred embodiment according to the present invention, the sensing device 102 is a photosensitive switch 1023. The photosensitive switch 1023 includes a photo diode 215 and a photo transistor 213. The photo transistor 213 and the photo diode 215 are respectively installed on the property and a fixed article (such as a exhibition stand or any un-removable article). When the movement of the property is abnormal, that is, when a distance between the photo diode 215 and the photo transistor 213 exceeds the predetermined distance, the photosensitive switch 1023 would be triggered and the sensing device 102 would be changed from the initial state to the alert state, so as to trigger the radio transmitting circuit 104 to transmit the radio signal.

In the property anti-theft apparatus of one embodiment according to the present invention, the transmitting unit 100 further includes a data input device 107. The data input device 107 is used for inputting an identification code. The identification code represents relevant data of a corresponding property, and the radio signal transmitted by the radio transmitting circuit 104 includes this identification code. Accordingly, when the property has been stolen to cause the radio transmitting circuit 104 to transmit the radio signal, the receiving unit 110 could acquire relevant data (such as a property number, location, and so on) of the property according to identification code of the received radio signal.

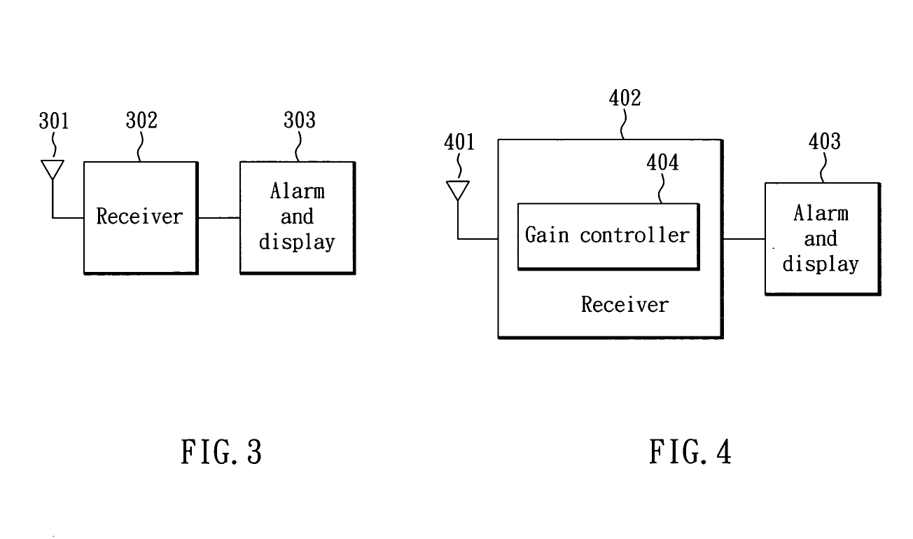

Next, please refer to both FIG. 1 and FIG. 3. FIG. 3 illustrates a schematic drawing of the receiving unit 110 of one preferred embodiment according to the present invention. In the property anti-theft apparatus of one preferred embodiment according to the present invention, the receiving unit 110 includes an antenna 301, a receiver 302 and an alarm and display 303. The antenna 301 and the receiver 302 are used for receiving the radio signal and acquiring the relevant data of the property according to the identification of the radio signal. When receiving the radio signal, the alarm and display 303 is used for issuing a warning sound or light signal, and displaying the relevant data of the property.

Next, please refer to both FIG. 1 and FIG. 4. FIG. 4 illustrates a schematic drawing of a receiving unit of another preferred embodiment according to the present invention. In this embodiment, the receiving unit 101 includes an antenna 401, a receiver 402 and an alarm and display 403. The receiver 402 further includes a gain controller 404 capable of adjusting the magnitude for receiving the radio signal. The antenna 401 and the receiver 402 are used for receiving the radio signal and acquiring the relevant data of the property according to the identification code of the radio signal. When receiving the radio signal, the alarm and display 403 is used for issuing a warning sound or light signal, and displaying the relevant data of the property. Further, the alarm and display 303 could change the volume of the warning sound or the brightness of the light signal according to the magnitude of the received radio signal. Therefore, when the receiving unit 101detects that the property has been stolen and issues the warning sound or light signal, the user could control the gain controller 404 to lower the magnitude for receiving the signal, and move the location of the receiving unit 101. Until the magnitude of the received radio signal turns strong again, the user controls the gain controller 404 to lower the magnitude for receiving the signal again, and then moves the location of the receiving unit 101. By means of repeating the above steps, the user gets closer and closer to the location of the stolen property, thereby finding out the stolen property.

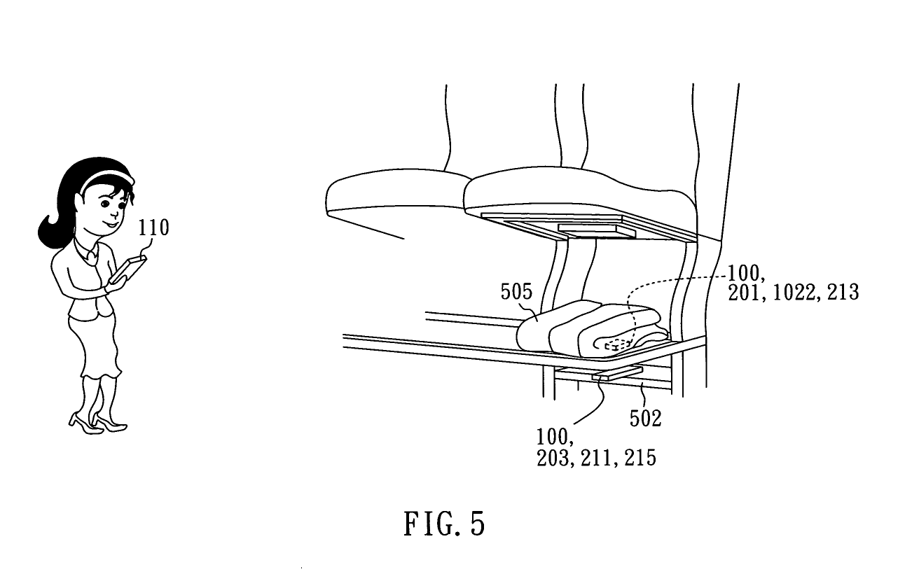

Please refer to FIG. 5. FIG. 5 illustrates a schematic drawing of a life jacket anti-theft apparatus of one preferred embodiment according to the present invention. In this embodiment, the property is a life jacket 505 provided for a passenger on an airplane. The receiving unit 110 is possessed by a flight attendant, and the transmitting unit 100 is installed on the life jacket 505 and a chair stand 502 under the life jacket 505. That is, the magnetic reed tube 201, the micro switch 1022 or the photo transistor 213 of the transmitting unit 100 is installed on the life jacket 505, while the magnet 203, the protruding block 211 or the photo diode 215 is installed on the fixed chair stand 502. The sensing device 102 of the transmitting unit 100 is used for sensing the movement of the life jacket 505. When the life jacket 505 is slightly touched by the passenger, the sensing device 102 would not be triggered. However, when the sensing device 102 senses that the movement of the life jacket 505 exceeds a predetermined distance, the radio transmitting circuit 104 would be triggered to transmit the radio signal, such that the flight attendant could be aware that the life jacket 505 has been stolen due to inappropriate movement.

According to the above description, the present invention has at least the following advantages:

1. The property anti-theft apparatus of the present invention allows the property to be moved within a predetermined range. Therefore, consumers are allowed to view or touch the property at short distance, thereby raising their purchasing will.

2. When the movement of the property exceeds the predetermined range, the sensing device would immediately sense that the movement state of the property is abnormal, and issue an alert signal. Because the sensing device is equipped with a latch circuit to prevent the state from returning to the initial state, it is able to avoid the anti-theft apparatus from being turned off by the thief to lose the anti-theft effect.

3. The battery supplies power to the radio transmitting circuit only when the sensing device senses that the movement of the property exceeds the predetermined distances. If the status of the property is normal, there is no need for power consumption, so as to efficiently achieve the effect of saving power.

4. The transmitting unit could include a data input device for inputting an identification code representing relevant data of the monitored property. When the property has been stolen, the radio signal transmitted by the radio transmitting circuit would include such identification code. According to the identification code, the relevant data could be recorded thus facilitating the searching process.

5. The receiving unit could include a gain controller having a gain value, and a second antenna. The second antenna is used for receiving the radio signal transmitted by the radio transmitting circuit. The gain value varies in accordance with a magnitude of the radio signal transmitted by the radio transmitting circuit, and a location of the property would be confirmed by means of adjusting the gain controller to control the gain value. Therefore, not only the user could be immediately informed when the property has been stolen, but also the user could take a positive way to track its location to get back the property.

Although the present invention has been explained in relation to its preferred embodiment, it is to be understood that many other possible modifications and variations can be made without departing from the spirit and scope of the invention as hereinafter claimed.

What is claimed is:

1. A property anti-theft apparatus, comprising:
a transmitting unit, installed on a property, the transmitting unit including a sensing device and a radio transmitting circuit, the sensing device being used for sensing a movement of the property, wherein when the sensing device senses that the movement of the property exceeds a predetermined distance, the sensing device triggers the radio transmitting circuit to transmit a radio signal; and
a receiving unit, for receiving the radio signal so as to alert the movement of the property.

2. The property anti-theft apparatus as claimed in claim 1, wherein the sensing device has a latch circuit, and when the sensing device senses that the movement of the property exceeds a predetermined distances to cause the property from an initial state to an alert state, the latch circuit is used to prevent the sensing device from returning to the initial state.

3. The property anti-theft apparatus as claimed in claim 2, further comprising a battery for supplying power to the radio transmitting circuit transmit the radio signal when the initial state been changed to the alert state.

4. The property anti-theft apparatus as claimed in claim 2, wherein the sensing device is a magnetic reed switch including a magnetic reed tube and a magnet, and when a distance between the magnetic reed tube and the magnet exceeds the predetermined distance, the magnetic reed switch is triggered and the sensing device is changed from the initial state to the alert state.

5. The property anti-theft apparatus as claimed in claim 2, wherein the sensing device is a micro switch including two pins and one terminal, and when a distance between the terminal of the micro switch and a fixed protruding block exceeds the predetermined distance, the micro switch is triggered and the sensing device is changed from the initial state to the alert state.

6. The property anti-theft apparatus as claimed in claim 2, wherein the sensing device is a photosensitive switch including a photo diode and a photo transistor, and when a distance between the photo diode and the photo transistor exceeds the predetermined distance, the photosensitive switch is triggered and the sensing device is changed from the initial state to the alert state.

7. The property anti-theft apparatus as claimed in claim 2, wherein the transmitting unit further comprises a data input device for inputting an identification code representing relevant data of a corresponding property, and the radio signal transmitted by the radio transmitting circuit includes the identification code.

8. The property anti-theft apparatus as claimed in claim 7, wherein the receiving unit comprises a first antenna for receiving the radio signal and acquiring the relevant data of the property according to the identification code of the radio signal.

9. The property anti-theft apparatus as claimed in claim 2, wherein the receiving unit comprises a gain controller and a second antenna for receiving the radio signal transmitted by the radio transmitting circuit, so that a location of the property is confirmed by means of controlling the gain controller to adjust a magnitude of the received signal.
